(19) United States
(12) Patent Application Publication
(10) Pub. No.: US 2013/0225103 A1
(43) Pub. Date: Aug. 29, 2013

(54) MOBILE TERMINAL WITH SUPPORT

(71) Applicant: Pantech Co., Ltd., (US)

(72) Inventor: Kyu Gap LEE, Seoul (KR)

(73) Assignee: Pantech Co., Ltd., Seoul (KR)

(21) Appl. No.: 13/771,739

(22) Filed: Feb. 20, 2013

(30) Foreign Application Priority Data
Feb. 24, 2012 (KR) 10-2012-0019060

(51) Int. Cl. H04B 1/38

(52) U.S. Cl. CPC H04B 1/3827
USPC 455/90.3

(57) ABSTRACT

Provided is a mobile terminal including a body unit providing a display unit; and a power unit supplying electric power to operate the display unit, wherein the power unit is mounted on one side of the body unit in a form such that the power unit extends in a direction parallel to a longitudinal direction of the side of the body unit, and allows for the center of gravity of the body unit to be eccentric toward the side of the body unit. According to such a configuration, a design freedom may be improved and a diversity of usage may be obtained.

### CROSS-REFERENCE TO RELATED APPLICATION

This application claims priority from and the benefit under 35 U.S.C. §119(a) of Korean Patent Application No. 10-2012-0019060, filed on Feb. 24, 2012, which is hereby incorporated by reference for all purposes as if fully set forth herein.

### BACKGROUND

1. Field

Exemplary embodiments of the present invention relate to a mobile terminal.

2. Discussion of the Background

A general terminal, i.e., a device enabling a user to exchange a signal with others, includes a mobile communication terminal, which allows a user to communicate with others while in motion, such as a cellular phone, a Personal Communication Service (PCS), a Personal Digital Assistant (PDA), or the like. Also, a small and mobile computer, e.g., a tablet device, is recently being provided as a mobile terminal.

In this instance, a battery for supplying electric power is mounted on the mobile terminal. However, in case of the battery, a capacity greater than a determined capacity is provided so that the battery maintains operation of the mobile terminal over a long period of time. The battery is generally mounted on a back side of a body of the mobile terminal to occupy as small an area as possible. A design freedom of the mobile terminal is limited due to the battery of the mobile terminal and thus, an aesthetic property of the mobile terminal is also degraded.

### SUMMARY

Exemplary embodiments of the present invention provide a universal serial bus (USB) device to establish an electrical connection between a main printed circuit board (PCB) and a terminal portion according to a movement of the USB device.

Additional features of the invention will be set forth in the description which follows, and in part will be apparent from the description, or may be learned by practice of the invention.

Exemplary embodiments of the present invention provide a mobile terminal, including a body unit to house a display unit, a power unit disposed in the body unit at a first side of the body unit, and a support rotatably connected to the body unit at opposite sides of the body unit, the opposite sides each being adjacent to the first side.

Exemplary embodiments of the present invention provide a mobile terminal, including a body unit to house a display unit, a control unit, and a power unit, and a support rotatably connected to the body unit, wherein the control unit and the power unit are disposed in the body unit and the support is connected to the body unit so that the mobile terminal has a center of gravity disposed eccentric toward a first side of the body unit.

Exemplary embodiments of the present invention provide a mobile terminal, including a body unit to house a display unit, a control unit, and a power unit, the control unit and the power unit being disposed at a first side of the body unit, and a support rotatably connected to the body unit at the first side of the body unit.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is an exploded perspective view schematically illustrating a mobile terminal according to exemplary embodiments of the present invention.

FIG. 2 is a perspective view schematically illustrating an assembled state of the mobile terminal shown in FIG. 1.

FIG. 3 is a top view schematically illustrating the mobile terminal shown in FIG. 2.

FIGS. 4, 5, 6, 7, and 8 are diagrams schematically illustrating a variety of setting positions of the mobile terminal according to exemplary embodiments of the present invention.

FIG. 9 is a perspective view schematically illustrating a state in which a camera is mounted on the mobile terminal according to exemplary embodiments of the present invention.

FIG. 10 is a perspective view schematically illustrating a state in which a projector is mounted on the mobile terminal according to exemplary embodiments of the present invention.

FIG. 11 is a perspective view schematically illustrating a state in which a resource for displaying a virtual keyboard is mounted on the mobile terminal according to exemplary embodiments of the present invention.

FIG. 12 is a cross-sectional view schematically illustrating a mobile terminal according to exemplary embodiments of the present invention.

FIG. 13 is a side view schematically illustrating a setting position of the mobile terminal shown in FIG. 12.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that when a member is referred to as being “connected to” another member, it may be directly connected to the other member, or intervening members may be present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

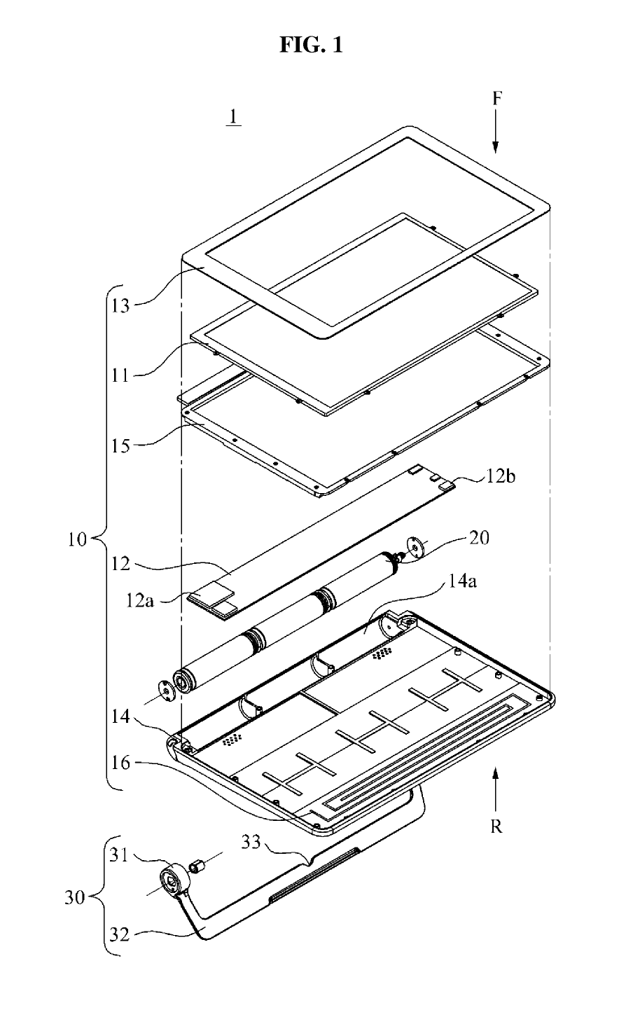

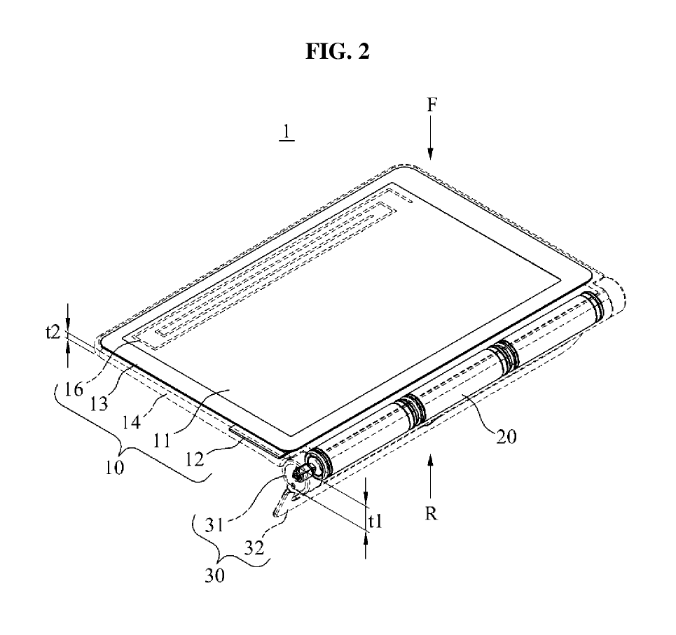

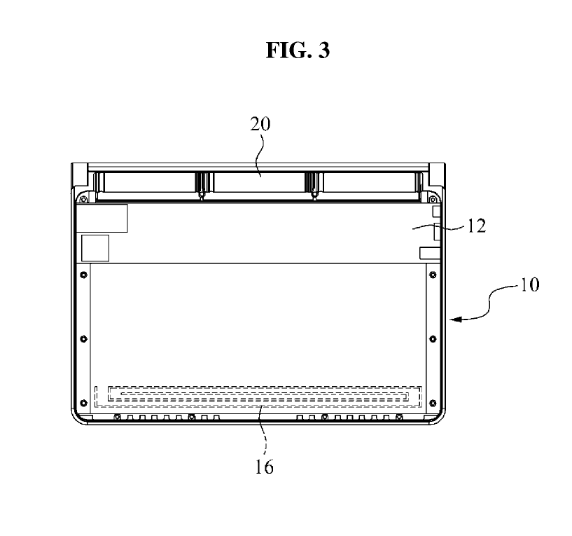

FIG. 1 is an exploded perspective view schematically illustrating a mobile terminal according to exemplary embodiments of the present invention. FIG. 2 is a perspective view schematically illustrating an assembled state of the mobile terminal shown in FIG. 1. FIG. 3 is a top view schematically illustrating the mobile terminal shown in FIG. 2. Referring to FIG. 1, a mobile terminal 1 includes a body unit 10 and a power unit 20.

The body unit 10 is a body of the mobile terminal 1 and houses a display unit 11, a control unit 12, which controls the display unit 11, and an antenna 16 for a wireless communication. The body unit 10 includes a first body 13, which supports a front F of the display unit 11, and a second body 14, which is connected with the first body 13 in the state that the display unit 11 is arranged between the first body 13 and the second body 14 and supports a rear R of the display unit 11 in order to support the display unit 11, the control unit 12, and the antenna 16. A third body 15 may be disposed between the rear of the display unit 11 and the second body 14 to support the rear R of the display unit 11.

The display unit 11 may include a general display, such as a Liquid Crystal Display (LCD), Organic Light Emitting Diode (OLED) display, plasma display, and the like. The display unit 11 displays determined information and inputs a control signal using a touch method. The display unit 11 is exposed toward the front F, as illustrated in FIG. 2, to display information and to input a control signal. However, aspects need not be limited thereto such that the display unit 11 may exposed toward the rear R or may be exposed toward both the front F and the rear R.

Although it is illustrated that the display unit 11 may use a touch type method to input a control signal, the input method is not limited thereto. For example, the display unit 11 may be configured such that a certain predetermined motion may be recognized as a control signal and thus, a method for inputting a gesture and/or combinations of gestures may be applicable.

The control unit 12 controls the display unit 11, and includes a Printed Circuit Board (PCB) on which a circuit pattern is disposed. The control unit 12 is electrically connected to the display unit 11 to electrically control information determined to be displayed by the display unit 11. Although the modules are not shown in detail in the control unit 12, an identification module 12a, such as a Subscriber Identification Module (SIM), a charging module 12b for electrically charging a power unit 20 and the like are provided.

As illustrated in FIGS. 1 through 3, the control unit 12 is mounted in the body unit 10 to be located relatively close to an end or side (i.e., a first side) of the body unit 10. In this instance, an area for mounting the control unit 12 is narrower than the area of the body unit 10, i.e., the control unit 12 need not extend to cover the entire area of the body unit 10, or that the control unit 12 is disposed at one side of the body unit 10 and extends between the two opposing sides of the body unit 10 adjacent to the one side at which the control unit 12 is disposed.

The control unit 12 may control the display unit 11, the identification module 12a, and the charging module 12b as well as components such as a speaker, a camera, an ear jack, and/or a data connection port, for example, a Universal Serial Bus (USB) port, which may be applied to the terminal 1 (not shown).

The antenna 16 is disposed on the second body 14 opposite the control unit 12 and may be a patterned antenna. The mounted location and pattern shape of the antenna 16 may not be limited to those illustrated in FIG. 1. For example, the antenna 16 may be provided in the third body 15, which is unexposed by the display unit 11. The antenna 16 may be mounted to be located relatively close to another end or side (i.e., a second side) of the body unit 10, so as to be spaced at a distance sufficiently apart from the control unit 12, which is mounted to be located relatively close to the first side of the body unit 10. The antenna 16 is located at a distance from the control unit 12, so as to prevent an antenna band shifting phenomenon caused by the signal sensitivity of the antenna 16 for a wireless communication. Further, the antenna 16 may be disposed at a distance from the gripping position. Accordingly, the antenna 16 is mounted on the second side of the body unit 10, so as to improve the quality of a variety of wireless communication technologies of the terminal 1, such as a third Generation (3G), a fourth Generation (4G), a Bluetooth (BT), or a WiFi scheme.

The power unit 20 supplies electric power to operate the display unit 11. The power unit 20, such as a general battery, is provided in the state that a certain amount of electric power for operating the mobile terminal 1 is stored. The power unit 20 is charged in a state in which the power unit is electrically connected to the charging module 12b provided in the control unit 12, so as to be used semi-permanently.

As illustrated in FIGS. 1 and 2, the power unit 20 is mounted to be located relatively close to an end or side of the body unit 10 and to have a form such that the power unit extends in parallel to a longitudinal direction of the end of the body unit 10. Further, the power unit 20 may be disposed between the control unit 12 and the first side of the body unit 10 adjacent to the control unit 12. The cross-section of the power unit 20 is circular, and the power unit 20 is mounted on the first side of the body unit 10 in a form such that at least one column extends in a longitudinal direction of the first side of the body unit 10. The first side of the body unit 10 adjacent to the power unit 20 and the control unit 12 may have a round shape corresponding to the shape of the power unit 20. Although the cross-section of the power unit 20 is described as circular as an example, the cross-section is not limited thereto such that a variation in which the section of the power unit 20 is polygonal is also possible. Furthermore, the length of the power unit 20 may not be limited to that shown as an example.

As illustrated in FIG. 2, the thickness t1 of the power unit 20, i.e., the cross-sectional diameter, is larger than the thickness t2 of the second side of the body. The body unit 10 has a slim shape in the direction from the first side to second side, so that a space in which the control unit 12 may be mounted to be located relatively close to the first side of the body unit 10 may be obtained, and the center of gravity of the body unit 10 may be eccentric toward the first side of the body unit 10 adjacent to the power unit 20 and the control unit 12. That is, the power unit 20 and the control unit 12 are also mounted to be located relatively close to the first side of the body unit 10, so that the weight of the body unit 10 is eccentric toward the first side of the body unit 10. The offset weight of the body unit 10 improves the gripping property of a user holding the first side of the body unit 10. Furthermore, the power unit 20 provided on the first side of the body unit 10 is provided at a distance from the antenna 16 provided on the second side of the body unit 10, so as to prevent the wireless communication of the antenna 16 from being electronically interfered with, and allows for performance of the antenna 16 to be improved.

A plurality of the power units 20, which may have the same capacities, respectively, may be provided and each mounted on the first side of the body unit 10 in a direction parallel to a longitudinal direction of the first side of the body unit 10. However, aspects need not be limited thereto such that the power unit 20 may be provided in a single unit. As illustrated in FIG.1, the power unit 20 may be disposed in a seating trough 14a provided in the first side of the second body 14 of the body unit 10.

The mobile terminal 1 further includes a support 30, which is rotatably mounted on the first side of the body unit 10 and rotatable on an axis of the power unit 20. The support 30 provides a setting position of the body unit 10. As illustrated in FIGS. 1 and 2, the support 30 is includes a pair of connecting portions 31 which face each other to be axially connected to opposite sides of the body unit 10 at ends of the power unit 20, and a supporting portion 32 which extends between the connecting portions 31 to support the body unit 10 in a determined setting position. Although mobile terminal 1 is illustrated as including the support 30, aspects need not be limited thereto such that a different support may be included or no support need be included and one or more of the control unit 12, the power unit 20, and other units and resources may disposed in the body unit 10 to provide for an eccentric center of gravity.

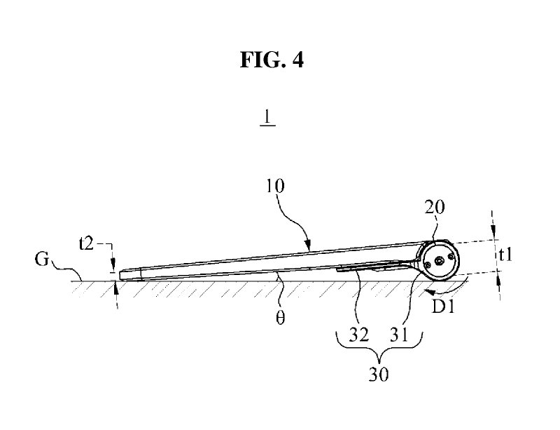

Although the supporting portion 32 is illustrated as having a relatively “E” shape and extending between the connecting portions 31, aspects need not be limited thereto such that the supporting portion may have a different shape. For example, the supporting portion 32 may be curved or have several curves or may be thicker or thinner in portions. As illustrated in FIGS. 4 through 7, the supporting portion 32 is rotatable in a first direction D1 toward the rear R of the body unit 10 and a second direction D2 away from the body unit 10 so as to support a setting position of the body unit 10. Although the rotation angle of the supporting portion 32 is not shown in detail, the angle may be adjustable in multiple stages by a resource for guiding rotation, such as a cam. In addition, the supporting portion 32 provides a supporting notch 33 which hangs the body unit 10 on a protrusion (not shown) such as a nail in a wall.

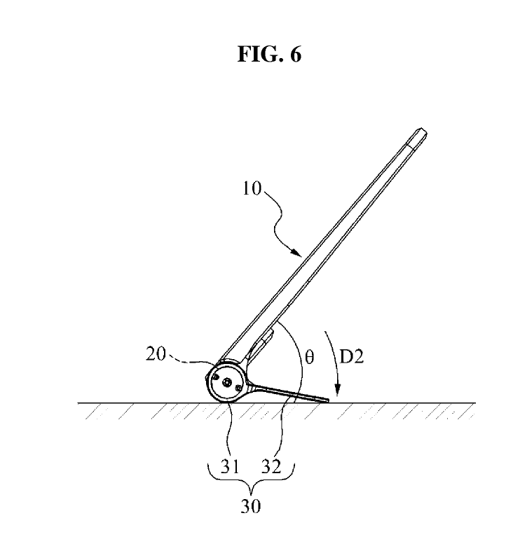

Furthermore, as illustrated in FIGS. 1 through 3, the control unit 12 and the power unit 20 are mounted on the first side of the body unit 10, so that the center of gravity of the body unit 10 is eccentric toward the first side of the body unit 10. The length of the supporting portion 32 extending from the connecting portions 31 of the support 30 may be determined in consideration of the center of gravity of the body unit 10. That is, as illustrated in FIG. 6, the length of the supporting portion 32 may be determined to support a setting position of the body unit 10 using only the support 30 based on the center of gravity of the body unit 10.

Examples of various setting positions using the offset weight of the mobile terminal 1 are described in detail with reference to FIGS. 4 through 8.

FIGS. 4, 5, 6, 7, and 8 are diagrams schematically illustrating a variety of setting positions of the mobile terminal according to exemplary embodiments of the present invention. FIG. 4 is a diagram illustrating a state in which the supporting portion 32 of the support 30 is rotated in the first direction D1, and disposed adjacent to the rear R of the body unit 10. The supporter may be attached to the rear R of the body unit 10. In this instance, the supporting portion 32 does not support the body unit 10, and the body unit 10 is set against a surface G so that the front F of the body unit 10 is exposed. Here, the body unit 10 is inclinedly disposed on the surface G due to the thickness t1 of the power unit 20 disposed on the first side of the body unit 10, and thus, the display unit 11 is exposed. The body unit 10 in such a position may be supported on the surface G such that the front F of the body unit 10 is disposed at an angle of inclination θ of approximately five degrees, i.e., an angle which is suitable to input a control signal, such as typing, through the display unit 11.

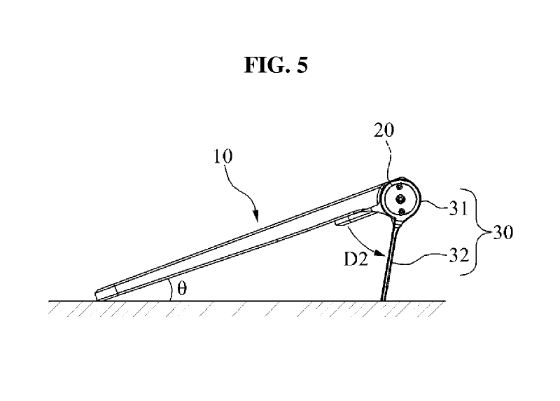

As illustrated in FIG. 5, when the supporting portion 32 of the support 30 is rotated on an axis of the connecting portions 31 toward the second direction D2, i.e., away from the rear R of the body unit 10, the second side of the body unit 10 as well as an end of the supporting portion 32 are set against the surface G to support a setting position of the body unit 10. The body unit 10 may be supported by the support 30 such that the front F of the body unit 10 is disposed at an angle of inclination θ of approximately twenty degrees against the surface G. A control signal, such as typing, may be inputted and information displayed through the display unit 11, such as a video, may be viewed, at an angle of inclination θ as illustrated in FIG. 5.

FIG. 6 is a diagram illustrating a modified setting position of the body unit 10 in the state that the support 30 is rotated in the second direction D2 away from the rear R of the body unit 10. As illustrated in FIG. 6, the body unit 10 is supported against the surface G at an angle of inclination θ of approximately fifty degrees using the support 30. Here, the length of the supporting portion 32 extending from the connecting portions 31 may be determined in consideration of the center of gravity of the body unit 10, which includes the display unit 11, the control unit 12, and the power unit 20, so that a setting position of the body unit 10 may be supported only by the support 30. As illustrated in FIG. 6, an angle of inclination θ of the body unit 10 is suitable for watching information, such as a video, through the display unit 11 of the body unit 10.

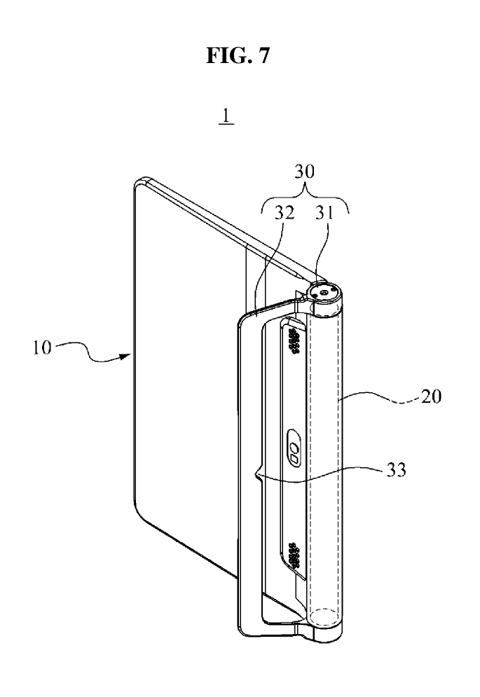

In addition, FIG. 7 illustrates a state in which the body unit 10 in FIG. 6 is rotated, and a setting position of the body unit 10 is set upon a third side of the body unit 10 and the support 30. The third side of the body unit 10 is a side of the body unit 10 disposed between and connecting the first side and the second side of the body unit 10. The body unit 10 having such a setting position shown in FIG. 7 is also suitable for watching information through the display unit 11. In case of FIG. 7, the center of gravity of the body unit 10 becomes eccentric so that a position of the body unit 10 is set.

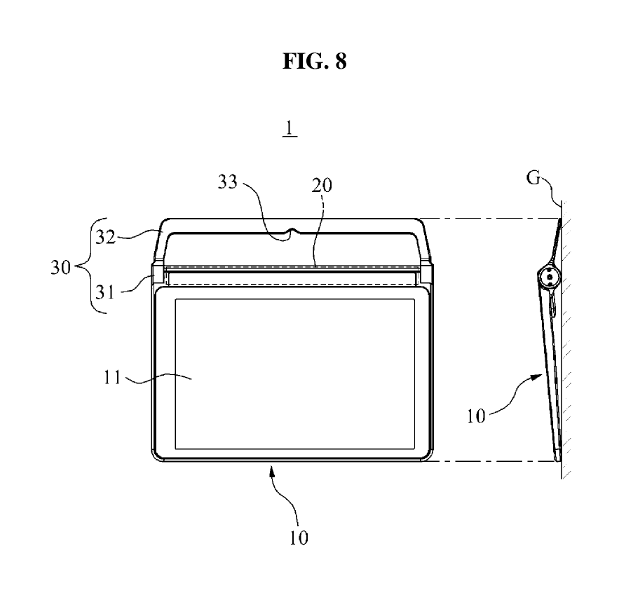

As illustrated in FIG. 8, the supporting portion 32 of the support 30 is rotated in the second direction D2 more than the supporting portion 32 as shown in FIGS. 5, 6, and 7 so that the body unit 10 may be hanged on a surface G, such as a wall surface, using the supporting notch 33. The body unit 10 maybe, for example, a type of wall hanging. The support 30 may be rotated and fixed at at least two positions, and a determined protrusion (not shown) is inserted into the supporting notch 33, so that the body unit 10 is hanged from a wall. Here, the location for mounting the supporting notch 33 is provided relatively in a middle of the supporting portion 32 to support a setting position of the body unit 10, and the number of the supporting portions 33 is not limited to the number illustrated as an example. Further, the support 30 may be rotatable between and fixable at more than two positions; for example, the support 30 may be rotatable between and fixable at 3, 4, 5, or more positions between the front F and the rear R of the body unit 10.

Components configuring the mobile terminal 1, such as a speaker, a camera, an ear jack, and/or a USB port (not shown) may be also mounted on the first side of the body unit 10 located nearer to the control unit 12, which are electrically connected with each other, so as to assist the center of gravity of the body unit 10 to be eccentric toward the first side of the body unit 10 due to the weight of the power unit 20.

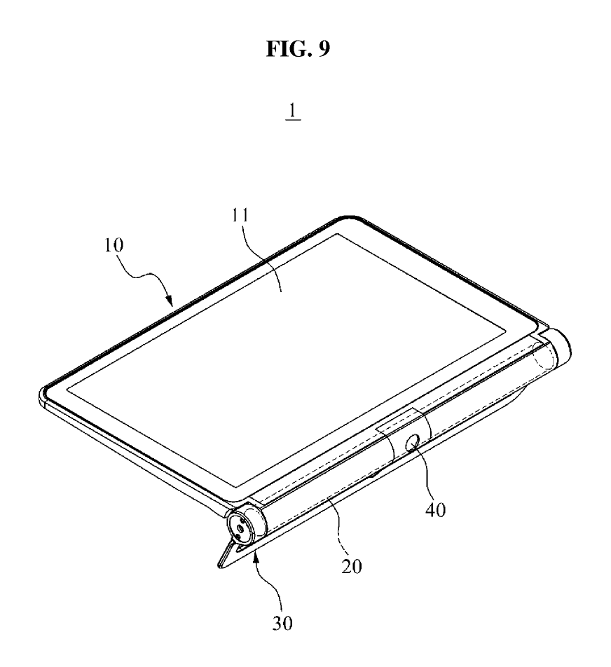

FIG. 9 is a perspective view schematically illustrating a state in which a camera is mounted on the mobile terminal according to exemplary embodiments of the present invention. For example, as illustrated in FIG. 9, a camera 40 may be mounted on the first side of the body unit 10 in which the power unit 20 and the support 30 are provided. The camera 40 is mounted on a rounded first side of the body unit 10 to correspond to the shape of the power unit 20, which is so formed such that the first side of the body unit 10 has a column shape. The camera 40 may be moveable in the first direction D1 and the second direction D2. In this instance, although the camera 40 is not shown in detail, a determined driving resource, such as a stepping motor, may be used to operate the camera. The camera 40 is mounted on the first side of the body unit 10 so as to assist the weight of the body unit 10 to be eccentric toward the first side of the body unit 10.

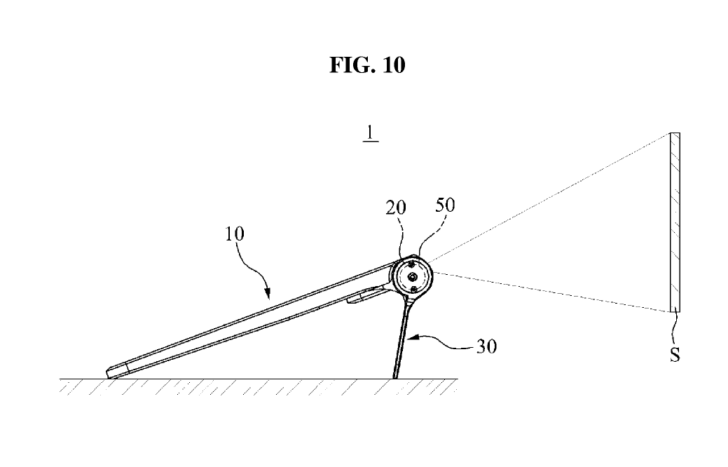

FIG. 10 is a perspective view schematically illustrating a state in which a projector is mounted on the mobile terminal according to exemplary embodiments of the present invention. As illustrated in FIG. 10, a projector 50 is mounted on the first side of the body 10 in which the power unit 20 and the support 30 are provided, so as to display a determined video on the screen S. The projector 50 may be rotatable in the first direction D1 and the second direction D2. Although mobile terminal 1 is illustrated in FIG. 10 as including the support 30, aspects need not me limited thereto such that a different support may be included or no support need be included and one or more of the control unit 12, the power unit 20, the projector 50, and other units and resources may disposed in the body unit 10 to provide for an eccentric center of gravity.

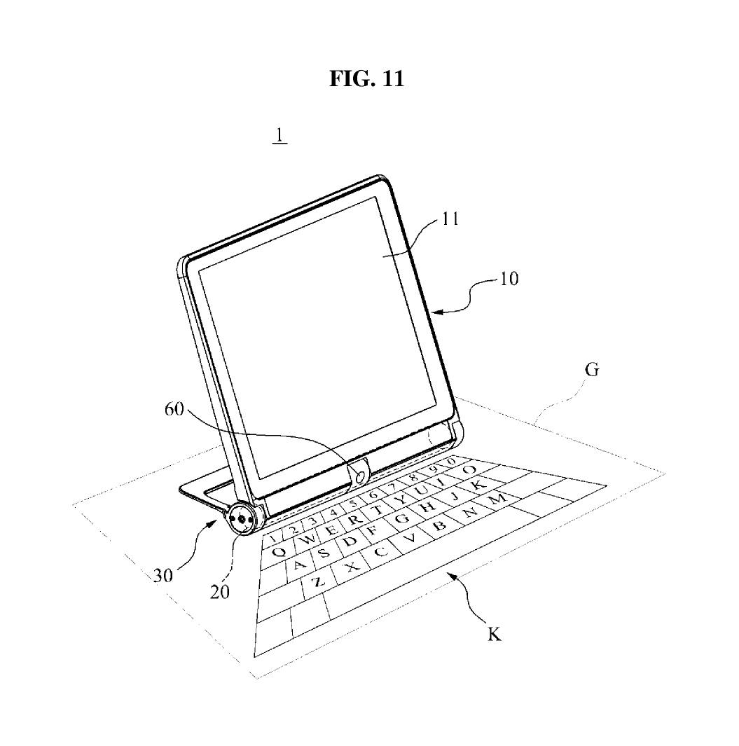

FIG. 11 is a perspective view schematically illustrating a state in which a resource for displaying a virtual keyboard is mounted on the mobile terminal according to exemplary embodiments of the present invention. As illustrated in FIG. 11, a keyboard resource 60, which projects a keyboard video for forming a virtual keyboard on a surface G, may be mounted on the first side of the body unit 10. The keyboard resource 60 may be rotatable in the first direction D1 and the second direction D2. Further, the keyboard resource 60 may include an infrared (IR) sensor, a laser from which the virtual keyboard is generated, and a camera. Although not shown, the laser may be disposed at the second side of the body unit 10 and the camera may be disposed in the body unit 10 between the laser and the IR sensor. Although mobile terminal 1 is illustrated in FIG. 11 as including the support 30, aspects need not me limited thereto such that a different support may be included or no support need be included and one or more of the control unit 12, the power unit 20, the keyboard resource 60, and other units and resources may disposed in the body unit 10 to provide for an eccentric center of gravity

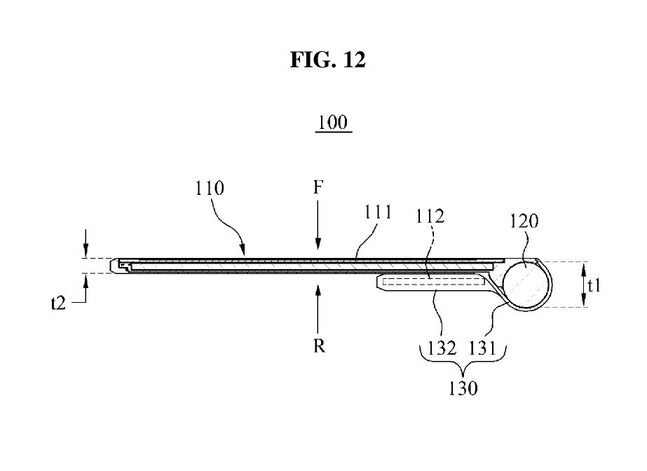

FIG. 12 is a cross-sectional view schematically illustrating a mobile terminal according to exemplary embodiments of the present invention. Referring to FIG. 12, a mobile terminal 100 includes a body unit 110 and a power unit 120.

The body unit 110 is a body of the mobile terminal 100 providing a display unit 111 and a control unit 112. The display unit 111 includes a transparent display resource, such as an LCD or the like. Although the body unit 110 may be configured by a plurality of bodies to provide the display unit 111, a detailed illustration is omitted because the body unit 110 has a same or similar configuration as that illustrated in FIG. 1. The control unit 112 is disposed relatively close to the first side of the body unit 110, and as illustrated in FIG. 12, a supporter 130 is connected to the first side of the body unit 110 and supports a setting position. The control unit 112 is disposed in the supporter 130, and thus, the thickness t2 of the body unit 110 may become slimmer due to the location of the control unit 112. Here, an antenna 16 for a wireless communication may be provided to be located relatively close to the second side of the body unit 110 opposite the first side of the body unit 110.

The power unit 120 is disposed on the first side of the body unit 110 in a form such that the power unit extends in a direction parallel to a longitudinal direction of the body unit 110. Although the cross-section of the power unit 120 is illustrated as circular, and the power unit has a column shape having the thickness t1 greater than the thickness t2 of the body unit 110, aspects need not be limited thereto such that the power unit 120 may have a polygonal cross-section and/or may be disposed in other forms along the first side of the body unit 110.

As described in the foregoing, the power unit 120 is mounted on the first side of the body unit 110, so that the weight of the first side of the body unit 110 is relatively greater in comparison with that of the second side of the body unit 110 due to the location of the power unit 120, which causes the center of gravity of the body unit 110 to be eccentric toward the first side of the body unit 110.

A setting position of the body unit 110 using the offset center of gravity, which is caused by the power unit 120 being disposed on the first side of the body unit 110, is supported by the supporter 130. The supporter 130 is rotatably mounted on the first side of the body 110 to be rotated about an axis of the power unit 120. The supporter 130 includes connecting portions 131, which are connected at the first side of the body unit 110, and a supporting portion 132 which extends from and between the connecting portions 131. In this instance, the control unit 112 is disposed in the supporting portion 132.

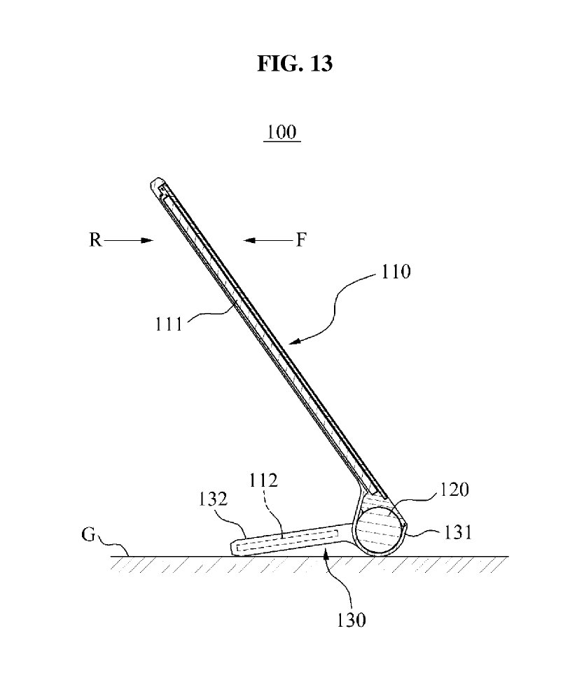

The thickness t2 of the body unit 110 having the display unit 110 may be decreased by disposing the control unit 112 in the supporter 130. The control unit 112, when separately mounted on the supporter 130, does not block the display unit 111 and thus, the display unit 111 employing a transparent display resource may be exposed toward the front F and the rear R, which improves a displaying property. FIG. 13 is a side view schematically illustrating a setting position of the mobile terminal shown in FIG. 12. As illustrated in FIG. 13, the body unit 110 is inclinedly supported against a surface G, so that determined information may be displayed to and a control signal may be inputted simultaneously by a user toward the front F and the rear R. Here, a setting position of the body unit 110 may be also changeable in various configurations as illustrated in FIGS. 4 through 11.

Exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, a power unit is mounted on one a first side of the body unit in a form such that the power unit extends in parallel to a longitudinal direction of the first side of a body unit, so as to make a position for mounting the body unit to be stable due to the weight and location of the power unit, which may improve a gripping property. The power unit may be mounted on the first side of the body unit, so as to improve a design freedom and an aesthetic property based on a slimmed thickness. A supporter, which changes a position by being rotated on an axis of the power unit and supports a setting position of the body unit is, provided to provide a variety of setting positions of the body unit, which may provide more positions in which the device may be used. A control unit may be provided on the supporter mounted on the power unit, so as to make the terminal to be slimmer. An antenna may be provided on the second side of the body unit distanced from the power unit, so as to prevent a signal transmission and reception from being interfered with, which may cause the quality of a wireless communication to be improved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a body unit to house a display unit;
a power unit disposed in the body unit at a first side of the body unit.

2. The mobile terminal of claim 1, further comprising:
a support rotatably connected to the body unit at opposite sides of the body unit, the opposite sides each being adjacent to the first side

3. The mobile terminal of claim 1, further comprising a control unit disposed in the body unit at the first side of the body unit.

4. The mobile terminal of claim 2, further comprising a control unit disposed in the support.

5. The mobile terminal of claim 1, further comprising an antenna disposed in the body unit at a second side of the body unit, the second side being opposite the first side of the body unit.

6. The mobile terminal of claim 1, wherein the power unit extends along the first side of the body unit.

7. The mobile terminal of claim 6, further comprising:
a support rotatably connected to the body unit at opposite sides of the body unit at locations aligned with the power unit, the opposite sides each being adjacent to the first side.

8. The mobile terminal of claim 1, wherein the power unit has a circular cross-section and is disposed in a longitudinal direction along the first side of the body unit, the circular cross-section being taking in a plane normal to the longitudinal direction.

9. The mobile terminal of claim 8, wherein a diameter of the circular cross-section of the power unit is greater than a thickness of the second side of the body unit.

10. The mobile terminal of claim 8, further comprising:
a support rotatably connected to the body unit at opposite sides of the body unit, the opposite sides each being adjacent to the first side, the support being rotatable about an axis of the power unit in the longitudinal direction.

11. The mobile terminal of claim 2, wherein the support is rotatable between positions at which the support is fixable.

12. The mobile terminal of claim 2, wherein, if the support is rotated in a second direction away from a rear of the body unit and disposed at a position extending away from the rear of the body unit, and if the mobile terminal is set on a surface to be supported by a second side of the body unit and an end of the support, a front of the body unit forms an angle of about 20 degrees with the surface on which the mobile terminal is set.

13. The mobile terminal of claim 2, wherein, if the support is rotated in a second direction away from a rear of the body unit and disposed at a position extending away from the rear of the body unit, and if the mobile terminal is set on a surface to be supported by only the support, a front of the body unit forms an angle of about 50 degrees with the surface on which the mobile terminal is set.

14. The mobile terminal of claim 2, wherein, if the support is rotated in a second direction to extend away from first side of the body unit in a direction opposite from a direction in which the body unit extends, an end of the support and a second side of the body unit opposite the first side support the mobile terminal when hanged on a wall by the support.

15. The mobile terminal of claim 2, wherein the support comprises a supporting notch.

16. The mobile terminal of claim 2, wherein the support comprises:
connecting portions which face each other and are axially connected to the opposite sides at ends of the power unit; and
a supporting portion which extends between the connecting portions to support the body unit in a determined setting position.

17. The mobile terminal of claim 1, further comprising a camera disposed on the first side of the body unit.

18. The mobile terminal of claim 1, further comprising a projector disposed on the first side of the body unit.

19. The mobile terminal of claim 1, further comprising a keyboard resource disposed on the first side of the body unit, the keyboard resource to project a keyboard video to form a virtual keyboard on a surface.

20. A mobile terminal, comprising:
a body unit to house a display unit, a control unit, and a power unit,
wherein the control unit and the power unit are disposed in the body unit so that the mobile terminal has a center of gravity disposed eccentric toward a first side of the body unit.

21. A mobile terminal, comprising:
a body unit to house a display unit, a control unit, a power unit, and at least one of a camera and a projector, the control unit, the power unit, and the at least one of the camera and the projector being disposed at a first side of the body unit.
